(19) United States
(12) Patent Application Publication
(10) Pub. No.: US 2014/0368328 A1
(43) Pub. Date: Dec. 18, 2014

(54) VEHICLE STATE DISPLAY APPARATUS AND METHOD

(71) Applicant: HYUNDAI MOBIS CO., LTD., Seoul (KR)

(72) Inventor: Min Jae CHOI, Yongin-si (KR)

(73) Assignee: HYUNDAI MOBIS CO., LTD., Seoul (KR)

(21) Appl. No.: 14/178,928

(22) Filed: Feb. 12, 2014

(30) Foreign Application Priority Data
Jun. 12, 2013 (KR) 10-2013-0067450

(51) Int. Cl. B60K 35/00

(52) U.S. Cl. CPC B60K 35/00; B60K 2350/352; B60K 2350/1072; B60K 2350/106
USPC 340/461

(57) ABSTRACT

A vehicle state display apparatus includes: a sensor unit configured to sense a state and information of a vehicle, including vehicle speed; a cluster control unit configured to receive the state and information of the vehicle, sensed by the sensor unit, and display the received state and information; an AVN (Audio-Video Navigation) control unit configured to receive the state and information of the vehicle from the cluster control unit; and an AVN display unit configured to display the state and information of the vehicle according to control of the AVN control unit.

### CROSS-REFERENCES TO RELATED APPLICATIONS

The present application claims priority to Korean application number 10-2013-0067450, filed on Jun. 12, 2013, which is incorporated by reference in its entirety.

### BACKGROUND OF THE INVENTION

The present invention relates to a vehicle state display apparatus and method, and more particularly, to a vehicle state display apparatus and method which is capable of displaying the state and information of an electric vehicle on an AVN (Audio-Video Navigation) system at the same time while displaying the state and information on a cluster, thereby improving reliability.

Electric vehicles which are powered by electricity emerged in the late 1880s, and were used for car, truck, and bus transportations. In the 1920s corresponding to the initial stage of the motor industry, the electric vehicles had a relatively low speed and a limited mileage due to battery recharging. In this age, however, the low speed and the limited mileage did not matter. Thus, the electric vehicles were luxury vehicles used in the city, and had been in competition with oil fuel vehicles which are motor trucks to connect points close to each other.

However, as the time passed, the electric vehicles gradually fell behind in the competition with the oil fuel vehicles, due to battery recharging. Recently, however, various countries of the world have paid' much attention to the electric vehicles, in order to reduce exhaustion of carbon dioxide caused by environmental pollution.

Furthermore, various countries of the world are putting much work into the spread of electric vehicles by constructing an infrastructure such as a charging station for recharging a battery, for example.

Recently, electric vehicles have been equipped with a cluster which displays the current state and information of the electric vehicles and an AVN system in which audio, video, and navigation functions are integrated therein and which is manipulated through a touch screen or dial, in order to display the current state and information of the electric vehicles. Thus, drivers' convenience has been improved.

The related art of the present invention is disclosed in Korean Patent Laid-open Publication No. 10-2012-0090659 published on Aug. 17, 2012 and entitled “Method and apparatus for operating AVN system for vehicles using voice recognition”.

In general, the AVN system is operated immediately after a vehicle is started. When information of the vehicle is to be displayed, the information of the vehicle is first displayed on the cluster. Then, the AVN system receives the information through the cluster and displays the received information.

At this time, the AVN system does not display the information as soon as the information is received from the cluster, but displays the information in a predetermined time after the information is received from the cluster, thereby causing a driver to feel a sense of difference. As a result, the reliability of the system may be degraded. Thus, there is a demand for an apparatus and method capable of solving such a problem.

### SUMMARY OF THE INVENTION

Embodiments of the present invention are directed to a vehicle state display apparatus and method which is capable of displaying the state and information of an electric vehicle on an AVN system at the same time while displaying the state and information on a cluster, thereby improving reliability.

In one embodiment, a vehicle state display apparatus may include: a sensor unit configured to sense a state and information of a vehicle, including vehicle speed; a cluster control unit configured to receive the state and information of the vehicle, sensed by the sensor unit, and display the received state and information; an AVN (Audio-Video Navigation) control unit configured to receive the state and information of the vehicle from the cluster control unit; and an AVN display unit configured to display the state and information of the vehicle according to control of the AVN control unit.

The cluster control unit may display the state and information of the vehicle, sensed by the sensor unit, on a cluster display unit.

The AVN control unit may receive the state and information of the vehicle from the cluster control unit through CAN communication.

The AVN control unit may display the state and information of the vehicle as animation on the AVN display unit, as soon as the state and information are received from the cluster control unit.

In another embodiment, a vehicle state display method may include: receiving, by an AVN control unit, a state and information of a vehicle, sensed by a sensor unit, through a cluster control unit, when the vehicle is started; and displaying the received state and information of the vehicle on an AVN display unit.

In the receiving of the state and information of the vehicle, the AVN control unit may receive the state and information of the vehicle, including vehicle speed, from the cluster control unit through CAN communication.

The cluster control unit may display the state and information of the vehicle, sensed by the sensor unit, on a cluster display unit.

In the displaying of the received state and information of the vehicle, the AVN control unit may display the state and information of the vehicle as animation, as soon as the state and information are received from the cluster control unit.

According to the embodiment of the present invention, the state and information of the vehicle may be displayed on the AVN system at the same time while the state and information are displayed on the cluster, which makes it possible to improve the reliability.

Furthermore, only software may be changed to display the state and information of the vehicle on the cluster and the AVN system at the same time, without changing hardware. Thus, it is possible to eliminate a sense of difference which may occur due to a time difference in display between the cluster and the AVN system, without a complex process.

### BRIEF DESCRIPTION OF THE DRAWINGS

FIG. 1 is a block configuration diagram of a vehicle state display apparatus in accordance with an embodiment of the present invention.

FIG. 2 is a diagram illustrating a cluster in the vehicle state display apparatus in accordance with the embodiment of the present invention.

FIG. 3 is a diagram illustrating an AVN system in the vehicle state display apparatus in accordance with the embodiment of the present invention.

FIG. 4 is a flowchart illustrating a vehicle state display method in accordance with an embodiment of the present invention.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

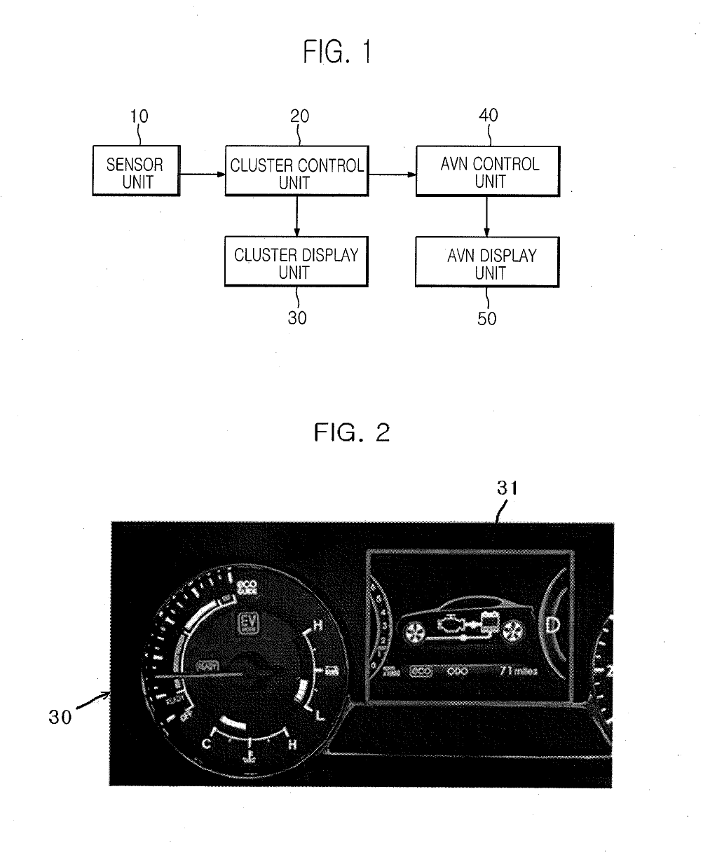

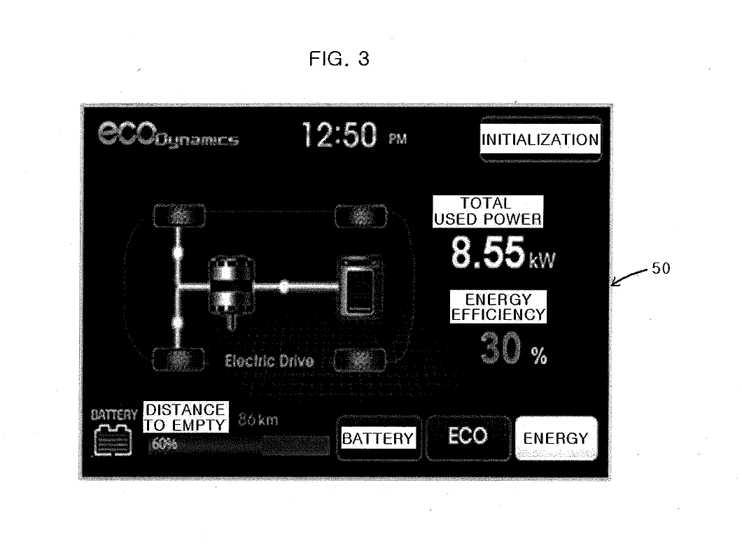

FIG. 1 is a block configuration diagram of a vehicle state display apparatus in accordance with an embodiment of the present invention. FIG. 2 is a diagram illustrating a cluster in the vehicle state display apparatus in accordance with the embodiment of the present invention. FIG. 3 is a diagram illustrating an AVN system in the vehicle state display apparatus in accordance with the embodiment of the present invention.

Referring to FIG. 1, the vehicle state display apparatus includes a sensor unit 10, a cluster control unit 20, a cluster display unit 30, an AVN control unit 40, and an AVN display unit 50.

The sensor unit 10 senses the state and information of a vehicle, including vehicle speed.

At this time, the sensor unit 10 includes a vehicle speed sensor, a temperature sensor, a battery sensor, a motor RPM sensor, an odometer, and a vehicle mode sensor. In addition, various sensors for sensing the current state and information of the vehicle may be applied.

The cluster control unit 20 receives the sensed state and information of the vehicle from the sensor unit 10, and displays the received state and information on the cluster display unit 30.

That is, the cluster control unit 20 receives the necessary state and information of the vehicle from the sensor unit 10 and displays the received state and information. In particular, the cluster control unit 20 may display the state and information as an image on a liquid crystal display unit 31 as illustrated in FIG. 2, such that a driver easily recognizes the state and information.

The cluster control unit 20 transmits the state and information of the vehicle to the AVN control unit 40 through CAN communication.

The AVN control unit 40 may display the state and information of the vehicle on the AVN display unit 50 as soon as the state and information are received from the cluster control unit 20, thereby eliminating a sense of difference which may occur due to a time difference in display between the cluster and the AVN system in the related art.

The AVN display unit 50 displays the state and information of the vehicle according to the control of the AVN control unit 40.

As illustrated in FIG. 3, the AVN control unit 40 may display the state and information of the vehicle as animation on the AVN display unit 50. Thus, a driver may easily recognize the state and information of the vehicle, while the animation interests the driver.

At this time, the AVN display unit 50 displays the state and information according to a mode selected by the driver, for example, battery, ECO, or energy.

According to the embodiment of the present invention, the state and information of the vehicle may be displayed on the AVN system at the same time while the state and information are displayed on the cluster, which makes it possible to improve the reliability of the apparatus.

Furthermore, only software may be changed to display the state and information of the vehicle on the cluster and the AVN system at the same time, without changing hardware. Thus, it is possible to eliminate a sense of difference which may occur due to a time difference in display between the cluster and the AVN system, without a complex process.

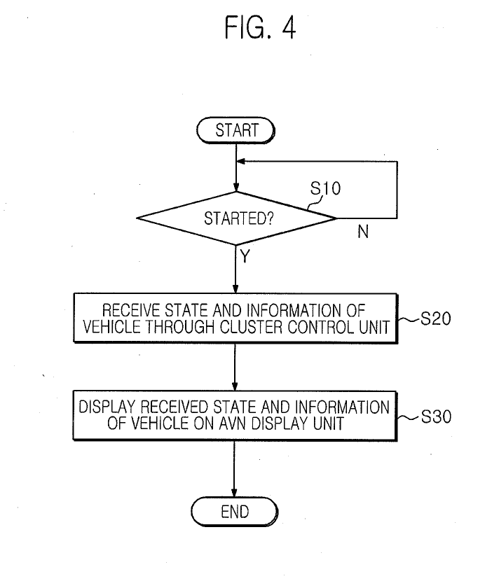

FIG. 4 is a flowchart illustrating a vehicle state display method in accordance with an embodiment of the present invention. Referring to FIG. 4, the operation of the present embodiment will be described in detail.

First, it is determined whether or not a vehicle is started, at step S10.

When the vehicle is started, the AVN control unit 40 receives the state and information of the vehicle, sensed by the sensor unit 10, through the cluster control unit 20, at step S20.

At this time, the sensor unit 10 includes a vehicle speed sensor, a temperature sensor, a battery sensor, a motor RPM sensor, an odometer, and a vehicle mode sensor. In addition, various sensors for sensing the current state and information of the vehicle may be applied.

Furthermore, the cluster control unit 20 receives the state and information of the vehicle, sensed by the sensor unit 10, and displays the received state and information on the cluster display unit 30.

The cluster control unit 20 transmits the state and information of the vehicle to the AVN control unit 40 through CAN communication.

Then, the AVN control unit 40 displays the received state and information on the AVN display unit 50 at step S30.

At this time, the AVN control unit 40 displays the state and information of the vehicle on the AVN display unit 50 as soon as the state and information are received from the cluster control unit 20, thereby eliminating a sense of difference which may occur due to a time difference in display between the cluster and the AVN system in the related art.

Furthermore, the AVN control unit 40 may display the state and information of the vehicle as animation on the AVN display unit 50. Thus, a driver may easily recognize the state and information of the vehicle, while the animation interests the driver.

According to the embodiment of the present invention, the state and information of the vehicle may be displayed on the AVN system at the same time while the state and information are displayed on the cluster, which makes it possible to improve the reliability.

Furthermore, only software may be changed to display the state and information of the vehicle on the cluster and the AVN system at the same time, without changing hardware. Thus, it is possible to eliminate a sense of difference which may occur due to a time difference in display between the cluster and the AVN system, without a complex process.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A vehicle state display apparatus comprising:
a sensor unit configured to sense a state and information of a vehicle, including vehicle speed;
a cluster control unit configured to receive the state and information of the vehicle, sensed by the sensor unit, and display the received state and information;
an AVN (Audio-Video Navigation) control unit configured to receive the state and information of the vehicle from the cluster control unit; and
an AVN display unit configured to display the state and information of the vehicle according to control of the AVN control unit.

2. The vehicle state display apparatus of claim 1, wherein the cluster control unit displays the state and information of the vehicle, sensed by the sensor unit, on a cluster display unit.

3. The vehicle state display apparatus of claim 1, wherein the AVN control unit receives the state and information of the vehicle from the cluster control unit through CAN communication.

4. The vehicle state display apparatus of claim 1, wherein the AVN control unit displays the state and information of the vehicle as animation on the AVN display unit, as soon as the state and information are received from the cluster control unit.

5. A vehicle state display method comprising:
receiving, by an AVN control unit, a state and information of a vehicle, sensed by a sensor unit, through a cluster control unit, when the vehicle is started; and
displaying the received state and information of the vehicle on an AVN display unit.

6. The vehicle state display method of claim 5, wherein in the receiving of the state and information of the vehicle,
the AVN control unit receives the state and information of the vehicle, including vehicle speed, from the cluster control unit through CAN communication.

7. The vehicle state display method of claim 5, wherein the cluster control unit displays the state and information of the vehicle, sensed by the sensor unit, on a cluster display unit.

8. The vehicle state display method of claim 5, wherein in the displaying of the received state and information of the vehicle,
the AVN control unit displays the state and information of the vehicle as animation, as soon as the state and information are received from the cluster control unit.
